(19) United States
(12) Patent Application Publication
(10) Pub. No.: US 2008/0032128 A1
(43) Pub. Date: Feb. 7, 2008

(54) Cellulosic moulded body and process for its manufacture

(75) Inventors: Josef Schmidtbauer, Vocklabruck (AT); Gert Kroner, Lenzing (AT); Christian Mechtler, Attersee (AT)

Correspondence Address: FITZPATRICK CELLA HARPER & SCINTO, 30 ROCKEFELLER PLAZA, NEW YORK, NY, 10112, US

(73) Assignee: Lenzing Aktiengesellschaft

(21) Appl. No.: 11/820,425

(22) Filed: Jun. 19, 2007

Related U.S. Application Data
(63) Continuation of application No. PCT/AT2005/000488, filed on Dec. 5, 2005.

(30) Foreign Application Priority Data
Dec. 23, 2004 (AT) A 2162/2004

(51) Int. Cl. D02G 3/00; B29C 39/14

(52) U.S. Cl. 428/372; 264/165

(57) ABSTRACT

The invention relates to a cellulosic moulded body, in particular a viscose fibre or a Lyocell fibre. The moulded bodies according to the invention contain a modifying substance in a microencapsulated form.

### CROSS REFERENCE TO RELATED APPLICATION

This application claims the benefit of Title 35, United States Code, Section 120 as a continuation of International patent Application No. PCT/AT2005/000488, filed on Dec. 5, 2005.

### BACKGROUND OF THE INVENTION

1. Field of the Invention

The present invention relates to a cellulosic moulded body, in particular a cellulose fibre, and to a process for its manufacture.

Today, cellulosic moulded bodies, in particular fibres, are produced essentially according to two processes:

In the viscose process, an alkaline cellulose xanthate solution is spun into one or several regenerating baths. Depending on the exact composition of the spinning dope (“viscose”) and the regenerating baths, the fibres are called viscose or modal fibres. The two groups are classified as generic terms by BISFA (The International Bureau for the Standardisation of Man Made Fibres).

In a more recent process, the cellulose is dissolved directly in a tertiary amine oxide, usually N-methylmorpholine-N-oxide, and is extruded through an air gap into a precipitation bath. According to BISFA, those fibres are referred to as Lyocell fibres. The manufacturing process is referred to as an “amine-oxide process” or a “Lyocell process”.

By means of those two processes, it is also possible to produce other moulded bodies such as, for example, films, membranes etc.

It is known to modify the moulded bodies, in particular fibres, produced, for example, according to the viscose process or the Lyocell process, with certain substances in order to achieve different effects such as, for instance, an improved colourability of the moulded bodies, an improved absorbing capacity, flame resistance etc. Those substances are summarized below under the term “modifying substance”.

However, many potential modifying substances are incompatible with the chemical or physical conditions of the viscose process.

It is known to use microcapsules as carriers of different active agents in numerous areas in order to manufacture products which consist of a base material and substances that are incompatible with said basic material and/or whose release should be controlled.

In the area of textile and fibre technologies, microcapsules are used mostly in the finishing of fibres and textiles in order to subsequently fix active agents to the (finished) fibres and textiles. In this regard, for instance, the teaching of EP-A 1 359 247 A1 is referred to. Depending on the choice of the materials used for encapsulation, the enclosed active agents can be released by diffusion or by mechanical or chemical stress, respectively. For some applications such as, for example, the use of heat storage materials, it is desirable and also feasible to encapsulate the active agents permanently.

A substantial disadvantage of said subsequent finishing of fibres or textiles with microencapsulated fibre-modifying substances consists in that the microcapsules are not bound permanently to the fibres and are removed by repeated washings.

U.S. Pat. No. 3,852,401 A describes a process for the manufacture of synthetic fibres from different synthetic polymers (but not viscose fibres) which contain microencapsulated fibre-modifying substances. In said process, the microcapsules are produced in situ in the spinning dope. U.S. Pat. No. 3,852,401 A indicates in particular that producing the microcapsules separately and admixing the microcapsules to the dope of the synthetic polymers gives rise to problems since the microcapsules will form larger aggregates due to the change in the dispersion medium, which aggregates then cannot be reduced to smaller pieces.

EP 0 306 202 B1 describes—also in terms of synthetic polymers but not with regard to viscose fibres—a process for the incorporation of microcapsules comprising heat storage substances.

Also in CN 1317608, the incorporation of such microcapsules into synthetic fibres, at a proportion of 30-80%, is described.

EP 1 367 152 A1 describes a process for the manufacture of fibres and non-woven fabrics produced therefrom from thermoplastic materials in which microcapsules containing aromatic substances are incorporated.

All the above-mentioned documents refer to synthetic fibres from synthetic polymers but not to cellulose fibres.

EP 0 687 313 describes a process involving hollow beads with a diameter of less than 1.5 μm in cellulose fibres. Said beads do not contain any modifying substance but they themselves serve as a delustering agent.

JP 2-154007 describes the manufacture of regenerated cellulose fibres in which microcapsules comprising aromatic substances are integrated. Concretely, the manufacture of fibres according to the copper-oxide ammonium process is described.

The present invention has as its object to provide cellulosic moulded bodies which contain modifying substances, in particular modifying substances which, per se, would be incompatible with the cellulosic moulded body and its manufacturing process, respectively (for example, the viscose process or the Lyocell process).

### SUMMARY OF THE INVENTION

Said object is achieved by means of a cellulosic moulded body which contains a modifying substance in a microencapsulated form.

Surprisingly, it has been found that, with the spinneret diameters and filters which are typical of the process, the admixing of aqueous suspensions of microcapsules, which per se are conventional, to a dope of the cellulose or a cellulose derivative does not lead to the problems as described in particular in U.S. Pat. No. 3,852,401, such as the aggregation of the microcapsules and, associated therewith, a pressure increase as well as spinning defects and finally a plugging of the filters and nozzles.

Thus, a moulded body can be produced which incorporates the microcapsules comprising the modifying substance, i.e. which contains the same within the cellulose matrix of the moulded body.

Advantageously, microcapsules up to a content of 30% by weight, based on the moulded body, can be incorporated.

Preferably, microcapsules are used which exhibit a size of 10 μm or less. This is markedly smaller than the microcapsules used in the copper-oxide ammonia process according to JP 2-154007.

Preferably, the microencapsulated modifying substance is selected from the group consisting of flame retardants, heat storage substances, aromatic substances, dyes, cosmetic agents and therapeutic agents. With that, especially permanently encapsulated heat storage substances (for instance, so-called Phase Change Materials) and flame retardants (for instance, red phosphorus) can be incorporated into the moulded body in an excellent fashion. The incorporation of substances which otherwise would not be compatible with the conditions of, for example, the viscose process or the Lyocell process proves to be particularly beneficial.

A person skilled in the art is familiar with processes for the microencapsulation of active agents and in particular with the control of the release of the active agent, for example, by appropriately selecting the material used for microencapsulation.

The moulded body according to the invention is preferably present in the form of a fibre, in particular in the form of a viscose fibre or Lyocell fibre.

The process for the manufacture of the moulded body according to the invention comprises the moulding of a dope of the cellulose or a cellulose derivative and is characterized in that microcapsules containing the modifying substance are added to the dope and/or to a precursor of the dope.

Preferably, the spinning dope is a viscose or a solution of cellulose in an aqueous tertiary amine oxide.

As precursors of the spinning dope, the starting materials and intermediates, respectively, in the above-defined viscose process and Lyocell process, respectively, are to be understood, i.e., in case of the viscose process, for example, the cellulosic starting material, the alkali cellulose or the cellulose xanthate prior to the dissolution, or in case of the Lyocell process, the cellulosic starting material, the used aqueous amine oxide or an aqueous suspension of cellulose in the amine oxide prior to the preparation of the solution.

Preferably, the microcapsules are added in the form of an aqueous suspension.

### DETAILED DESCRIPTION OF THE INVENTION

The invention is described in more detail by of the following nonlimiting working examples.

### EXAMPLES

In the examples, the following commercially available microcapsules containing fibre-modifying substances were used:

| Micro- | | | average | |
|---|---|---|---|---|
| capsule | wall material | Content | diameter | manufacturer |
| RT35vis2 | melamine- | paraffines | 2.2 μm | Messrs. AERO |
| | formaldehyde | | | (Celje, Slo.) |
| | resin | | | |
| Lav 50st | melamine- | dyes + | 1.9 μm | Messrs. AERO |
| | formaldehyde | essential | | (Celje, Slo.) |
| | resin | oils | | |
| Lav 50ta | melamine- | dyes + | 1.9 μm | Messrs. AERO |
| | formaldehyde | essential | | (Celje, Slo.) |
| | resin | oils | | |
| LD-dev | melamine- | Dyes | 2.3 μm | Messrs. AERO |
| | formaldehyde | | | (Celje, Slo.) |
| | resin | | | |
| Bayscent | polyurethane | essential | not | Messrs. Bayer |
| | resin | oils | specified | Chemicals |

### Example 1

A 10-percent aqueous microcapsule suspension (RT35vis2; Messrs. Aero, containing a Phase Change Material) was stirred into a viscose ready for spinning for the production of modal fibres (example (a)) at a concentration of 10% by weight (microcapsules based on cellulose), or was metered in continuously shortly before the spinning filtration (example (b)), respectively.

According to methods known per se, viscose fibres were produced and their tenacity was measured. During the spinning process, no pressure increase could be determined, neither prior to nor after the spinning filtration. The melting enthalpy of the incorporated Phase Change Material was determined by means of DSC (Differential Scanning Calorimetry) in the finished dried fibres.

| | % micro- | tenacity | elongation | melting enthalpy |
|---|---|---|---|---|
| Example | capsules | cond. [cN/tex] | cond.[%] | [J/g(fibre)] |
| (a) | 10 | 34.75 | 11.18 | 3.5 |
| (b) | 10 | 33.70 | 11.17 | 2.5 |

### Example 2

Different 10-percent aqueous microcapsule suspensions, namely (cf. the above table of type designations and manufacturers):
A: Lav 50st
B: Lav 50ta
C: LD-dev
D: Bayscent
   were stirred into a viscose ready for spinning for the production of modal fibres at concentrations of 1-6% by weight (microcapsules based on cellulose). The microcapsules contain dyes or dye precursors, respectively, and/or aromatic substances.

According to methods known per se, viscose fibres were produced and their tenacity was measured. During the spinning process, no pressure increase could be determined, neither prior to nor after the spinning filtration.

| | | tenacity | elongation |
|---|---|---|---|
| Microcapsule | % microcapsules | cond.[cN/tex] | cond.[%] |
| A | 5 | 36.36 | 13.69 |
| B | 5 | 35.86 | 13.52 |
| C | 1 | 36.94 | 11.58 |
| C | 2 | 35.26 | 11.63 |
| C | 4 | 35.77 | 12.24 |
| C | 6 | 31.31 | 11.90 |
| D | 5 | 27.85 | 10.85 |

### Example 3

A 30-percent aqueous microcapsule suspension (Type: LD-dev; Messrs. Aero) was metered into a viscose ready for spinning for the production of standard viscose fibres at concentrations of 5-30% by weight (microcapsules based on cellulose) continuously into the spinning pump and was mixed by means of a homogenizer arranged downstream. The microcapsules contain dyes.

According to methods known per se, viscose fibres were produced and their tenacity was measured. During the spinning process, no pressure increase could be determined, neither prior to nor after the spinning filtration.

| | | tenacity | elongation |
|---|---|---|---|
| Example | % microcapsules | cond.[cN/tex] | cond.[%] |
| (a) | 5 | 21.1 | 12.25 |
| (b) | 10 | 19.28 | 11.5 |
| (c) | 15 | 16.59 | 10.51 |
| (d) | 20 | 14.89 | 10.4 |
| (e) | 25 | 15.31 | 11.17 |
| (f) | 30 | 14.79 | 10.96 |

The successful incorporation of the microcapsules could be shown, on the one hand, by means of electron micrographs and, in case of microcapsules with incorporated dyes, also directly with photomicrographs.

What is claimed is:

1. A cellulosic moulded body, containing a modifying substance in a microencapsulated form.

2. A moulded body according to claim 1, characterized in that the microcapsules are contained at a proportion of up to 30% by weight, based on the moulded body.

3. A moulded body according to claim 1 or 2, characterized in that the modifying substance is encapsulated in microcapsules of a size of 10 μm or less.

4. A moulded body according to any of the preceding claims, characterized in that the modifying substance is selected from the group consisting of flame retardants, heat storage substances, aromatic substances, dyes, cosmetic agents and therapeutic agents.

5. A moulded body according to claim 4, characterized in that the modifying substance is a Phase Change Material.

6. A moulded body according to any of the preceding claims in the form of a fibre.

7. A moulded body according to claim 6, characterized in that the fibre is present as a viscose fibre or Lyocell fibre.

8. A process for the manufacture of a moulded body according to any of the preceding claims, comprising the moulding of a dope of the cellulose or a cellulose derivative, characterized in that microcapsules containing the modifying substance are added to the dope and/or to a precursor of the dope.

9. A process according to claim 8, characterized in that the microcapsules are added in the form of an aqueous suspension.

10. A process according to any of claims 8 to 9, characterized in that the spinning dope is
a viscose or a solution of cellulose in an aqueous tertiary amine oxide.
